(19) United States
(12) Patent Application Publication
(10) Pub. No.: US 2025/0029476 A1
(43) Pub. Date: Jan. 23, 2025

(54) ACCELLFX PROXIMITY DETECTION SYSTEM

(71) Applicant: Donnell Brian Dillon, Indianapolis, IN (US)

(72) Inventor: Donnell Brian Dillon, Indianapolis, IN (US)

(21) Appl. No.: 18/908,440

(22) Filed: Oct. 7, 2024

Related U.S. Application Data
(63) Continuation-in-part of application No. 16/946,921, filed on Jul. 10, 2020, now abandoned.

(51) Int. Cl. G08B 25/00; G01S 1/04; G01S 1/68; G01S 19/12; G08B 26/00

(52) U.S. Cl. CPC G08B 25/009; G01S 1/042; G01S 1/68; G01S 19/12; G08B 26/001

(57) ABSTRACT

Disclosed is a security system configured to provide an extra layer of security for any given premises. The system includes a monitoring device worn by a person of interest, usually a criminal out on parole. The system also includes a plurality of proximity sensors that detect the presence of signals emitted by the monitoring device. When detected, the proximity sensors relay identifying information from the monitoring device to a security panel. The security panel then alerts local law enforcement to the potential threat so they may respond accordingly. The present disclosure also includes a method of altering law enforcement with particular identifying data of an intruder. Lastly, the system to may be used to create a secure, wireless tether to track the safety and location of a dependent (e.g., a child, pet, or livestock).

### CROSS-REFERENCE TO RELATED APPLICATION

This application is a continuation-in-part of U.S. patent application Ser. No. 16/946,921, filed Jul. 10, 2020.

### BACKGROUND OF THE INVENTION

The invention relates to security systems and, more particularly, to proximity-triggered security systems.

Security systems have become a staple piece of technology implemented in homes, businesses, and schools to ensure a safe and secure environment. Security systems have been adapted and integrated to include intruder prevention, fire/smoke alarms, carbon monoxide alarms, and other features to protect occupants.

Further, the U.S. Justice System has implemented monitoring programs and technology to safely re-integrate and rehabilitate criminals back into society. However, although related, these technologies have little to no overlap. Thus, there exists a need for improvement in the field.

### SUMMARY OF THE INVENTION

Embodiments of the present disclosure are directed to provide new layers of security for homeowners, business owners, schools, and other institutions requiring the implementation of security systems. Specifically, the present disclosure monitors and alerts homeowners, remote security companies, and/or law enforcement to the presence of criminals that have been paroled as part of a rehabilitation program, including sexual offenders, individuals on restraining orders, or habitual offenders, to name a few.

The security system, in some embodiments, utilizes proximity sensors that are configured to receive/pick up signals transmitted by a monitoring device worn by the criminal/person of interest. The proximity sensors, through remote signals, receive identifying information, date and time information, and/or geolocation information from the monitoring device and transmit said information to a panel located on the premises of the secured location. The panel is configured to alert occupants of the secured location to the presence of the individual and, in some embodiments, display the identifying information of the criminal. The system is further configured to transmit said identifying information to local law enforcement and/or a central monitoring agency, such as a security company. Importantly, the system allows for access by all authorized law enforcement agencies, including local police, sheriffs' offices, fire departments, DEA, FBI, state and local courts, U.S. Marshalls, and the like.

Further, in some embodiments, the system is configured to store and retain identifying information, date/time information, and geolocation information transmitted by the proximity sensors. In this manner, the activity and whereabouts of a known criminal may be closely monitored to ensure compliance with parole requirements and/or to serve as a check in for Parole Officers.

The security system may also be utilized in a proactive approach, rather than a reactive approach. For example, a monitoring device may be given to a child to track their location to ensure safety. The proximity sensors utilized in the system can detect when the monitoring device leaves a certain area and track identifying information, date/time information, and the like. In the event multiple systems are implemented (for example, at a child's home and school), the systems are configured to work together to ensure the child is safely located where they should be. In this way, the system can track and store data (such as geolocation data) of the child in the event the child goes missing or runs away from home.

The present disclosure is also directed to a method of monitoring the security of a premises. When an individual with a monitoring device enters a range of a proximity sensor, the sensor sends identifying information stored and associated with the monitoring device to the system panel, generally located on the premises. The panel is configured to alert both persons or staff located on-site an alert local law enforcement and/or a central monitoring agency of the presence of a potential intruder. The local law enforcement and/or central monitoring agency can then dispense necessary intervention, as required.

### BRIEF DESCRIPTION OF THE DRAWINGS

FIG. 1 illustrates an embodiment of the security system.

FIG. 2 is a schematic of an embodiment of a method of monitoring the security of a secured premises.

FIG. 3 illustrates another embodiment and use of the disclosed security system.

FIG. 4 is a schematic of another embodiment of a method of securing a premises.

### DETAILED DESCRIPTION OF THE INVENTION

For the purposes of promoting an understanding of the principles of the invention, reference will now be made to certain embodiments and specific language will be used to describe the same. It will nevertheless be understood that no limitation of the scope of the invention is thereby intended, such alterations and further modifications, and such further applications of the principles of the invention as described herein being contemplated as would normally occur to one skilled in the art to which the invention relates. Additionally, in the detailed description below, numerous alternatives are given for various features. It will be understood that each such disclosed alternative, or combinations of such alternatives, can be combined with the more generalized features discussed in the Summary above, or set forth in the embodiments described below to provide additional disclosed embodiments herein.

The uses of the terms “a” and “an” and “the” and similar references in the context of the disclosure (especially in the context of the following claims) are to be construed to cover both the singular and the plural unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element.

Embodiments of the present disclosure are directed to provide new layers of security for homeowners, business owners, schools, and other institutions requiring the implementation of security systems. Specifically, the present disclosure monitors and alerts homeowners, remote security companies, and/or law enforcement to the presence of criminals that have been paroled as part of a rehabilitation program, including sexual offenders, individuals on restraining orders, or habitual offenders, to name a few.

The security system, in some embodiments, utilizes proximity sensors that are configured to receive/pick up signals transmitted by a monitoring device worn by the criminal/person of interest. The proximity sensors, through remote signals, receive identifying information, date and time information, and/or geolocation information from the monitoring device and transmit said information to a panel located on the premises of the secured location. The panel is configured to alert occupants of the secured location to the presence of the individual and, in some embodiments, display the identifying information of the criminal. The system is further configured to transmit said identifying information to local law enforcement and/or a central monitoring agency, such as a security company. Importantly, the system allows for access by all authorized law enforcement agencies, including local police, sheriffs' offices, fire departments, DEA, FBI, state and local courts, U.S. Marshalls, and the like.

Further, in some embodiments, the system is configured to store and retain identifying information, date/time information, and geolocation information transmitted by the proximity sensors. In this manner, the activity and whereabouts of a known criminal may be closely monitored to ensure compliance with parole requirements and/or to serve as a check in for Parole Officers.

The security system may also be utilized in a proactive approach, rather than a reactive approach. For example, a monitoring device may be given to a child to track their location to ensure safety. The proximity sensors utilized in the system can detect when the monitoring device leaves a certain area and track identifying information, date/time information, and the like. In the event multiple systems are implemented (for example, at a child's home and school), the systems are configured to work together to ensure the child is safely located where they should be. In this way, the system can track and store data (such as geolocation data) of the child in the event the child goes missing or runs away from home.

The present disclosure is also directed to a method of monitoring the security of a premises. When an individual with a monitoring device enters a range of a proximity sensor, the sensor sends identifying information stored and associated with the monitoring device to the system panel, generally located on the premises. The panel is configured to alert both persons or staff located on-site an alert local law enforcement and/or a central monitoring agency of the presence of a potential intruder. The local law enforcement and/or central monitoring agency can then dispense necessary intervention, as required.

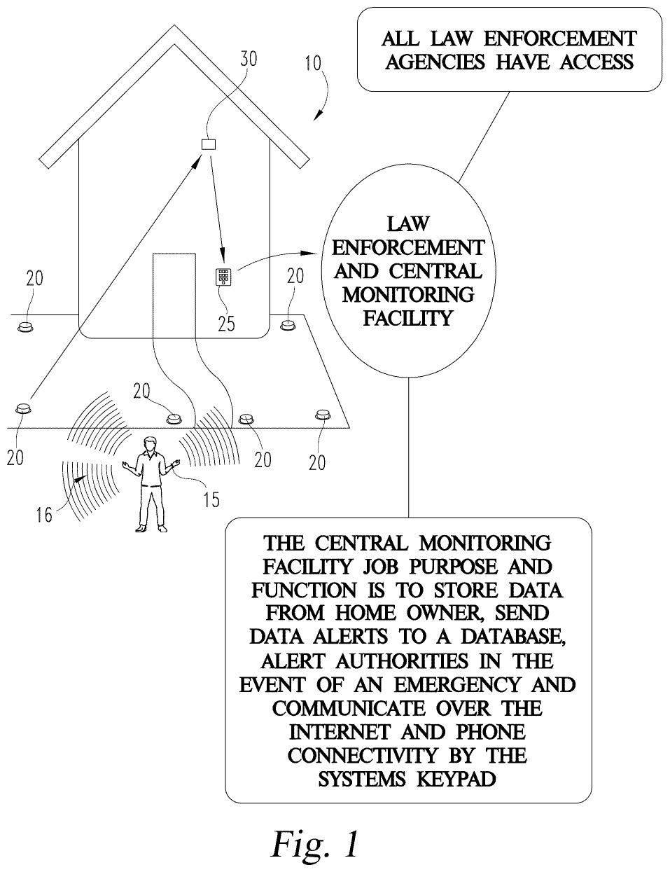

FIG. 1 illustrates an embodiment of the security system 10 according to the present disclosure in an exemplar use. The system 10 includes a monitoring device 15. The monitoring device 15 is a wearable device attached to a person of interest (i.e., a criminal out on parole). The monitoring device 15 is configured to send out signals 16 (e.g., via WiFi, BlueTooth, cellular, RFID, etc.) that contain identifying information of the person of interest that the device 15 is attached to. The signals are received by one or more proximity sensors 20 that are placed around the premises of a building to be secured by system 10. The proximity sensors 20 transmit the identifying information to a remote transceiver 30 connected to a security panel 25. In some embodiments, the remote transceiver 30 and the security panel 25 are one device. The security panel 25 transmits the information to a central monitoring facility and/or local law enforcement. Simultaneously, the security panel 25 alerts occupants of the building that a potential threat is on or near the premises. The central monitoring agency may separately contact law enforcement and may also store and track data received from one or more monitoring devices 15.

In some embodiments, the wearable monitoring device 15 is a bracelet, in other embodiments it is an anklet. Usually, monitoring device 15 is securely attached to the person of interest so it cannot be removed until the parole sentence is completed. In one embodiment of implementing security system 10, the monitoring device 15 is issued by courts and/or parole officers tasked with monitoring the activity/behavior of a criminal out on parole. The security system 10 thus integrates court-issued monitoring with home security to provide an added layer of protection and an added monitoring capabilities of law enforcement/courts.

The signal 16 emitted by the monitoring device 15, in some embodiments, contains identifying information associated with the person of interest wearing the device 15. For example, the signal may be embedded with an identification number that is associated with the individual. The signal 16 may also transmit date and time data, as well as geolocation information of the device 15. In the event of a crime, such data transmitted by signals 16 may be used by investigators/law enforcement to prove or disprove alibis or establish who committed a crime.

In other embodiments, the signal(s) 16 emitted by the monitoring device 15 transmit encrypted data through the proximity sensors 20/security panel 25/transmitter 30 to the monitoring facility and/or law enforcement, where the data is decrypted. The encrypted data emitted via signal(s) 16 may also include information related to the threat level of the individual wearing the monitoring device 15. The threat level, while encrypted, can be decrypted by the system to provide specific alerts/notifications to the homeowner. For example, during out-processing for criminals placed on parole, the encrypted data will include personal identifying information about the criminal. The data may also include specific details related to the criminal conduct/activity associated with the criminal. A criminal with a record related to selling drugs near a school or child sex offenders will alert a system 10/security panel 25 outfitted at a school of a high threat level, whereas a system 10 located near a neighborhood may indicate a medium or low threat level alert, depending on the distance from proximity sensors 20. In this manner, the system 10 is configured to provide generalized as well as specific alert notifications to owners of protected premises.

This may also include geographic information relevant to the criminal's record. For example, if a criminal was charged with burglary in a specific neighborhood, then the threat level alert notified to an owner of a house in that neighborhood would be higher than systems 10 located in other areas. The system 10 may be configured to provide various threat levels at varying degrees. For example, the system 10 may be configured to set threat levels at 1, 2, or 3, with 3 being the most severe. The system 10 may also set threat levels by color (e.g., green, yellow, or red). The security panel 25 may also produce increasingly loud alarms depending on the threat level of the near-by criminal. Further, such alerts, alarms, etc. may intensify as the monitoring device 20 gets closer to proximity sensors 20.

As the system 10/security panel 25 decrypts the threat level information tagged to the encrypted data emitted by the monitoring device 20, the threat level notification can be immediately alerted to an owner of a protected premises to allow for a quick, appropriate response, ensuring safety of the occupants.

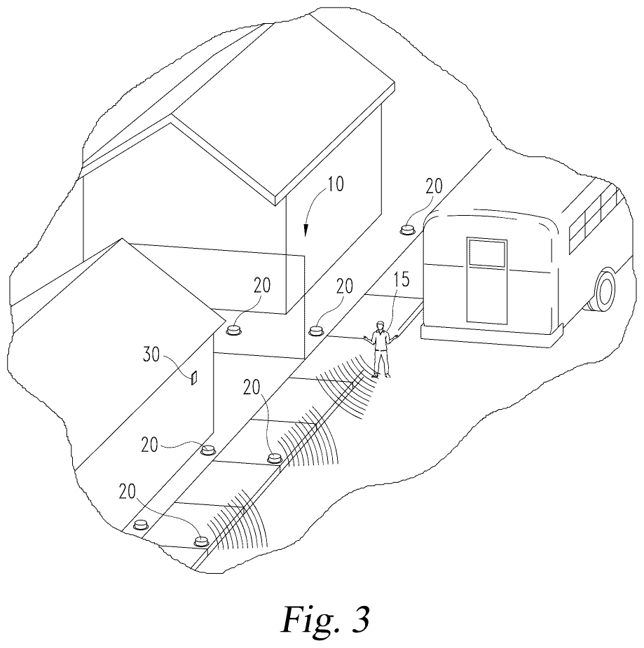

In other embodiments, the threat level associated with a monitory device 15 used as a tether (see FIG. 3 and related description) may be used in the inverse. For example, a threat level notification may increase in intensity (e.g., brighter and/or louder) as the tether moves away from known premises of the child wearing the monitoring device 15. In one embodiment, the security panel 25 sends out a high threat level when the monitoring device 15 is not in range of any proximity sensors 20 at any known locations of the child. The system 10 may be configured to allow for certain “blackout” times where the monitoring device 15 is known to be out of range from the dependent's known locations (e.g., vacation, on the bus to or from school, etc.).

The proximity sensors 20 receive and transmit the signals 16 emitted by the monitoring device 15. The sensors 20 are configured to receive signals 16 from any monitoring device 15, and are not limited to a particular ID/signal 16. The number of sensors implemented on a premises may depend on the size of the property and/or the level of protection desired. However, system 10 requires at least one sensor 20. The sensors 20 may receive and transmit signal 16 over WiFi, BlueTooth, RFID, or any other communications network. In other embodiments, the proximity sensors 20 may be hard-wired for a direct connection with security panel 25/transponder 30. In use, the sensors 20 transmit the signal 16 and any related information to the security panel 25 via the transmitter 30.

The security panel 25 is configured to receive the information/signal 16 from sensors 20/transmitter 30. The security panel 25 may alter occupants of the premises to the presence of an intruder/criminal outfitted with monitoring device 15. The security panel 25 is further configured to alter a central monitoring facility and/or local law enforcement. The alter to the central monitoring facility/local law enforcement may include identifying information emitted by monitoring device 15 through signal(s) 16. When an alter is received by the central monitoring facility/local law enforcement, appropriate action can be taken to ensure the safety of the occupants. The security panel 25, as known in the art, may include a display. The display may include alter information to warn the occupants of the premises to the potential threat, as well. In any event, the security panel 25 is configured to alter occupants to any security breaches via, for example, beeps, buzzes, vibrations, or notifications to a mobile app. The mobile app may be used to monitor the premises by occupants/owners of the property and/or the central monitoring facility and/or local law enforcement.

In some embodiments, security panels 25 located next to or near each other geographically, can communicate with one another (e.g., by a local area network transmitted through transmitters 30). For example, neighbors may allow their respective security panels 25 to communicate information between the systems, such as notifications, alerts, etc. If a first security system 10 is triggered by the presence of a monitoring device 15, then the system 10 can send “potential threat” notifications to neighboring systems 10 to alert a geographic area. In this way, a geographic area, such as a neighborhood, outfitted with two or more systems 10 creates a security blanket with the systems 10 sharing information, notifications, and alerts. This method also allows security companies or law enforcement to better log and track the movement of criminals outfitted with monitoring device 15. In another embodiment, the monitoring company or law enforcement can issue a “possible threat” notification to systems 10 located within a specified geographic area of a tripped system 10.

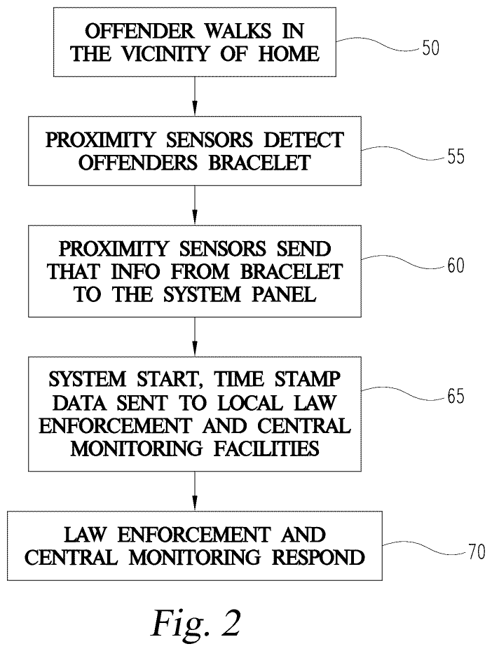

FIG. 2 is a schematic diagram of an exemplar method according to an embodiment of the present disclosure. At 55, a criminal outfitted with a monitoring device 15 walks into the vicinity of proximity sensors 20 set up around the perimeter of a premises. At 55, the proximity sensors 20 sense the signal 16 emitted by the monitoring device 15. The sensors may pick up the signals 16 emitted from the monitoring device at ˜30-150 feet. At 60, the proximity sensors 20 send the information received from the signals 16 of the device 15 to the security panel 25 via transmitter/transponder 30. The system 10/panel 25 relays the information received from sensors 20, along with time/date information, to a central monitoring facility and/or local law enforcement, at 65. At 70, the central monitoring facility/local law enforcement respond to the alter appropriately (e.g., based on the ID information and date/time information communicated via system 10).

FIG. 3 illustrates another embodiment/implementation of security system 10. In this embodiment, a child is outfitted with the monitoring device 15. Similarly, important premises are equipped with one or more proximity sensors. However, in this embodiment, the proximity sensors 20 send ID information, date/time information, etc. to the security panel 25 when the monitoring device 15 leaves the secured area. In this way, monitoring device 15 and proximity sensors 20 create a wireless communications tether that can track the location of the child. By outfitting multiple known locations (e.g., home, school, the bus, etc.) with proximity sensors 20, the whereabouts of the child can be monitored, or at the very least, location and date/time data may be stored at the central monitoring facility. In the event of an emergency, this information can be accessed by the central monitoring facility/parents or guardians of the child, via a mobile app, to determine the child's whereabouts. The security tether would greatly assist law enforcement in the event of an amber alert or other emergency. Although discussed with reference to a child, the system 10 could be implemented in other scenarios (e.g., the monitoring device 15 could be attached to a pet or livestock).

In one embodiment, the monitoring device 15 comprises a FOB that acts as a beacon. The monitoring device 15 is configured to emit a beacon signal that can be received by the system 10/panel 25. When the beacon signal is no longer picked up by the system 10, the system 10 is configured to send an alert and/or alarm. The alert may be sent to law enforcement, a remote monitoring facility, and/or the owners of the system 10. The alerts may be in the form of a notification, text message, phone call, etc.

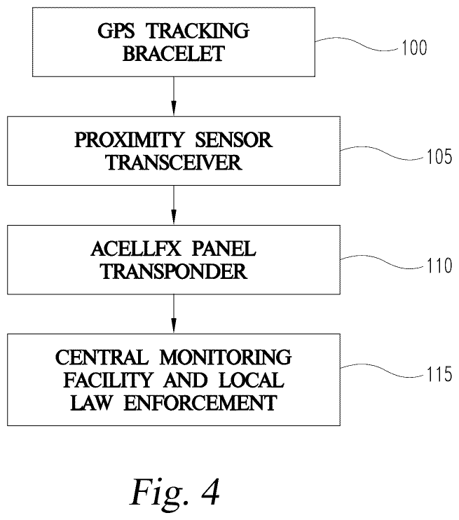

FIG. 4 is another schematic diagram of an exemplar method according to an embodiment of the present disclosure. At 100, a criminal outfitted with a monitoring device 15 that includes a GPS positioning locator walks into the vicinity of proximity sensors 20 set up around the perimeter of a premises. At 105, the proximity sensors 20 sense the signal 16 emitted by the monitoring device 15. The proximity sensors 20 send the information received from the signals 16 of the device 15, including GPS information, directly to the security panel 25. The system 10/panel 25 relays the information received from sensors 20, along with time/date information, to a central monitoring facility and/or local law enforcement, at 110. At 115, the central monitoring facility/local law enforcement respond to the alter appropriately (e.g., based on the ID information and date/time information communicated via system 10).

While the invention has been described in detail in the foregoing description, the same is to be considered as illustrative and not restrictive in character, it being understood that all changes and modifications that come within the spirit of the invention are desired to be protected. In addition, all references cited herein are indicative of the level of skill in the art and are hereby incorporated by reference in their entirety.

The following numbered clauses represent example embodiments according to the present disclosure:
1. An electronic monitoring system for monitoring a client, comprising: a transmitter worn by the client that transmits status data regarding status of the transmitter at one or more predetermined frequencies; a client tracking unit carried by the client that comprises a wireless voice and data communication device, a receiver that receives the status data transmitted by the transmitter, a GPS (Global Positioning System) receiver that receives time-coded position data derived from satellites of the Global Positioning System that indicate the geolocation of the client tracking unit over time, and a memory that stores the time-coded position data; a monitoring center for receiving and storing the status data and GPS data derived from the client tracking unit in a database, and a web server communicating with the database; a wireless portable monitoring device carried by a monitoring individual not located at the monitoring center and who is tasked with monitoring the client that comprises a wireless voice and data communication device, and a web browser that communicates with the database by way of the web server to selectively access data regarding the client to remotely monitor the client to track the location of the client over time; and a wireless communication link for communicating between the portable monitoring device, the client tracking unit, and the monitoring center.
2. The system recited further comprising: a monitoring unit for use by the client that comprises a receiver for receiving the data transmitted by the transmitter when it is in proximity thereof, and communication apparatus for downloading the data to the monitoring center.
3. The system recited in further comprising: a dock in communication with the monitoring unit that docks the client tracking unit and wherein the monitoring unit transmits the time-coded position information stored in the client tracking unit to the monitoring center by way of land communication lines when the client tracking unit is docked. The system recited in further comprising: a dock in communication with the monitoring unit that docks the client tracking unit and wherein the monitoring unit wirelessly transmits the time-coded position data stored in the client tracking unit to the monitoring center using SMS (Short Message Service) messages by way of the wireless communication link to the monitoring center when it is docked with the monitoring unit and when the landline communication link therebetween is inoperative.
4. The system recited wherein the receiver in the client tracking unit receives the predetermined data over first and second predetermined frequencies transmitted by the transmitter.
5. The system recited wherein the receiver in the monitoring unit receives the predetermined data over first and second predetermined frequencies transmitted by the transmitter.
6. The system recited in further comprising a field verification unit coupled to the wireless portable monitoring device that comprises one or more receivers that receive the data transmitted by the transmitter so as to remotely monitoring clients whose transmitters are within its range.
7. The system recited wherein the client tracking unit comprises software that monitors and reports transmitter proximity, monitors and reports strap status, and monitors and reports transmitter battery status.
8. The system recited wherein the memory of the client tracking unit stores restricted zone points, contact names and telephone numbers, and changeable transmitter identification data.
9. The system recited wherein the client tracking unit comprises a GSM (Global System for Mobile) capable cellular communication device that permits selective voice contact between the client and the monitoring center and the monitoring individual.
10. The method recited wherein the transmitting step transmits signals at two different frequencies separated in time.
11. The method recited wherein the accessing step comprises the step of: transmitting voice commands to the monitoring center using a portable wireless monitoring device that interfaces to the central database by way of web server and VXML interfaces to access and review the data and information relating to the client.
12. A method of electronically monitoring a client, comprising the steps of: providing the client with a wireless voice and data communication device having a GPS receiver and memory that stores time-coded position data corresponding to the location of the device derived from GPS satellites, and that comprises a receiver that receives signals from a body-worn transmitter comprising transmitter data that indicate the substantial collocation of the wireless communication device and the transmitter; transferring the time-coded position data and the transmitter data from the wireless communication device to a central database that stores data regarding the client; and remotely accessing the central database to access and review the time-coded position data and the transmitter data relating to the client to monitor the client.
13. The method recited wherein the transferring data step comprises the steps of: transferring the time-coded position data and the transmitter data from the wireless communication device to a monitoring unit; and transferring the time-coded position data and the transmitter data from the monitoring unit to the central database.
14. The method recited wherein the accessing step comprises the step of: remotely and wirelessly accessing the central database to access and review the time-coded position data and the transmitter data relating to the client to monitor the client.

15. The method recited wherein the step of transferring data to the monitoring unit comprises transferring substantially the same data at two different frequencies separated in time to the monitoring unit.

16. An electronic monitoring system for monitoring a client, comprising: a transmitter that transmits status data regarding status of the transmitter; a client tracking unit that comprises a GPS-enabled wireless voice and data communication device that receives time-coded position data derived from satellites of the Global Positioning System, and a memory that stores the time-coded position data, client tracking unit is in communication with the transmitter; a wireless communication link; and a wireless portable monitoring device that comprises a wireless voice and data communication device, for communicating with the client tracking unit by way of the wireless communication link to remotely monitor the client.
17. An electronic monitoring system for monitoring a client, comprising: a transmitter that transmits status data regarding status of the transmitter; a client tracking unit comprising a GPS-enabled wireless voice and data communication device that is in communication with the transmitter that receives time-coded position data derived from satellites of the Global Positioning System, and a memory that stores the time-coded position data, and, which client tracking unit communicates the status data and GPS location data relating to the client to the monitoring center for storage; a monitoring center for storing status data and GPS location data relating to the client; a wireless communication link; and a wireless portable monitoring device for communicating with the monitoring center by way of the wireless communication link to remotely monitor the client.
18. A method of electronically monitoring a client, comprising the steps of: providing the client with a client tracking unit comprising a GPS-enabled wireless voice and data communication device that receives time-coded position data derived from satellites of the Global Positioning System, and a memory that stores the time-coded position data, and that is in communication with a body-worn transmitter; providing a monitoring individual tasked with monitoring the client with a wireless portable voice and data communication device; and communicating between the client tracking unit and wireless portable voice and data communication device to remotely monitor the client.
19. The method recited in further comprising the steps of: transferring data derived from the client tracking unit device and the body-worn transmitter to a central database; and remotely accessing the central database from the wireless portable voice and data communication device to review the data relating to the client and thus monitor the client.
20. The method recited in wherein the step of remotely accessing the central database comprising the step of: wirelessly communicating between the wireless portable voice and data communication device and the database using a web browser and a web server.

1. A security system, comprising:
a plurality of monitoring devices respectively wearable by parolees, wherein each of the monitoring devices is associated with a unique identifier of a parolee and a threat level of the parolee and includes a transmitter to emit one or more signals containing said unique identifier and other status information;
one or more proximity sensors configured to detect the one or more signals emitted by each of the plurality of monitoring devices and transmit said unique identifiers and other status information;
a transponder configured to relay the one or more signals from each of the one or more proximity sensors to a security panel contained within a premises to be protected by the security system; and
the security panel, wherein the security panel alerts occupants of the premises that one or more of the proximity sensors has detected the signals emitted from any of the plurality of monitoring devices and alerts occupants of the threat level of the parolee;
wherein the monitoring devices includes a GPS antenna to provide geolocation data to a central monitoring facility and emit geolocation information detectable by the one or more proximity sensors;
wherein the alerts from the security panel are further transmitted to the central monitoring facility;
wherein the central monitoring facility includes a database for storing and accessing GPS-provided geolocation data and data provided from the security panel of the security system; and
wherein a second set of one or more proximity sensors located at a second premises are configured to detect the one or more signals emitted by the monitoring devices when in range and transmit said unique identifiers and other status information.

2. The security system of claim 1, wherein the threat level alert by the security panel increases in intensity as the monitoring device moves closer to the proximity sensors.

3. The security system of claim 1, wherein the security panel is configured to communicate with one or more other security panels located in a similar geographic area to send a potential threat notification to the one or more other security systems.

4. The security system of claim 1, wherein the one or more proximity sensors are evenly spread ˜30-150 feet apart defining a wireless perimeter.

5. The security system of claim 1, wherein the alerts generated by the security panel from detection of signals emitted by the monitoring device are also communicated to local law enforcement departments.

6. The security system of claim 1, wherein the alters generated by the security panel are communicated to a mobile application accessible by the owner of the premises, local law enforcement, and/or the central monitoring facility.

7. The security system of claim 1, wherein the signals emitted from the monitoring device communicate date and time information to the security panel via the proximity sensors.

8. The security system of claim 7, wherein the database at the central monitoring agency stores the date and time information.

9. The security system of claim 1, wherein the security panel includes a memory for storing information transmitted by the proximity sensors, wherein the information comprises the unique identifier of the monitoring device, GPS information, and/or date and time information.

10. The security system of claim 1, wherein the transponder is a component within the security panel.

11. A security system, comprising:
a plurality of monitoring devices, wherein the monitoring devices each includes a transmitter to emit one or more signals containing a unique identifier associated with the monitoring device and other status information;
one or more proximity sensors at a first known location configured to detect the one or more signals emitted by the monitoring device and transmit said unique identifier and other status information;
a transmitter configured to relay the one or more signals from the one or more proximity sensors to a security panel; and
the security panel, wherein the security panel generates an alert that one or more of the proximity sensors no longer detects the one or more signals emitted from the monitoring device;
wherein the monitoring device is wearable and/or attachable to a dependent;
wherein the one or more proximity sensors are placed at one or more known location of the dependent;
wherein the alert generated by the security panel includes a threat level that increases in intensity as the monitoring device moves away from the one or more proximity sensors located at one of the known locations of the dependent;
wherein a second set of one or more proximity sensors are located at a second known location and configured to detect the one or more signals emitted by the monitoring device and transmit said unique identifier and other status information to a security panel; and
wherein the security system defines a wireless tether to the dependent to track the location of said dependent between the known locations of the dependent.

12. The security system of claim 11, wherein the alert generated by the security panel is transmitted to local law enforcement and/or a central monitoring facility.

13. The security system of claim 12, wherein the central monitoring facility includes a database for storing GPS information, monitoring device status information, and/or date and time information transmitted by the one or more proximity sensors.

14. The security system of claim 12, wherein the monitoring device comprises a GPS antenna and the GPS data of the GPS antenna is accessible by a guardian of the dependent, local law enforcement, and/or the central monitoring facility.

15. The security system of claim 12, wherein the security panel generates an alert sent to a mobile application accessible by a guardian of the dependent, local law enforcement, and/or the central monitoring facility.

16. A method of tracking a person of interest, comprising:
attaching or securing a monitoring device to the person of interest;
detecting the presence of one or more signals generated by the monitoring device via one or more proximity sensors at a first location, wherein the signals include status information associated with the monitoring device;
transmitting the one or more signals and the status information from the one or more proximity sensors to a security panel via a transponder; and
generating an alert via the security panel when the one or more proximity sensors start detecting signals emitted from the monitoring device and/or when the one or more proximity sensors cease detecting signals emitted from the monitoring device;
wherein the one or more proximity sensors are programmed to detect signals generated by a plurality of monitoring devices;
wherein the one or more signals generated by the monitoring device are detectable by proximity sensors located at a second location; and
wherein the security panel is configured to communicate with one or more other security panels in order to send potential threat notifications to said one or more other security panels.

17. The method of claim 16, wherein the information associated with the monitoring device is communicated to a central monitoring facility and/or local law enforcement.

18. The method of claim 16, wherein the information comprises GPS information, a unique identifier associated with the monitoring device, and/or date and time information.

19. The method of claim 16, wherein the alert(s) generated by the security panel are communicated to a mobile application accessible by an owner of a secured premises or a guardian of a dependent.

20. The method of claim 17, wherein the central monitoring facility includes a database to store the information communicated from the security system.
